(19) United States
(12) Patent Application Publication
(10) Pub. No.: US 2013/0104189 A1
(43) Pub. Date: Apr. 25, 2013

(54) Controlling Transmission of Unauthorized Unobservable Content in Email Using Policy

(71) Applicant: Barracuda Networks, Inc., Campbell, CA (US)

(72) Inventor: Dean Drako, Austin, TX (US)

(73) Assignee: BARRACUDA NETWORKS, INC., CAMPBELL, CA (US)

(21) Appl. No.: 13/684,569

(22) Filed: Nov. 25, 2012

Related U.S. Application Data
(62) Division of application No. 12/351,812, filed on Jan. 10, 2009.

(51) Int. Cl. G06F 21/60

(52) U.S. Cl. CPC G06F 21/60
USPC 726/1; 726/26

(57) ABSTRACT

A system, method, and apparatus is disclosed to control mail server in handling encrypted messages according to a policy.

The present application is a division of currently pending Ser. No. 12/351,812 filed Jan. 10, 2009 which is incorporated in its entirety and which priority date is claimed.

### BACKGROUND

A corporate entity which provides access to a public network for its employees may be considered responsible for what is transmitted by email. Data or information sent attached to an email which can be traced to its servers could be considered attributable. While it is known that filters may inspect the message bodies of all email passing through a gateway, encrypted messages are not susceptible to control.

Due to privacy policies and regulatory requirements, personal private data which entities possess must be protected. Encrypted email is one of the ways that entities communicate with their clients, customers, patients, and contractors. Yet this same information must not be revealed to unauthorized recipients. So encrypted email must be distinguished between that allowed by policy and that which is outside a policy.

Thus it can be appreciated that what is needed is a way for mail service providers to secure their networks from transmitting unauthorized unobservable content.

### SUMMARY OF THE INVENTION

The present invention comprises an apparatus and a computer implemented method for blocking encrypted mail from passing into or out of a private network. The invention is placed between a mail server and the public network to intercept either incoming or outgoing email messages or can be a component of a mail server.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a block diagram of a data processor suitable for the implementation of this invention;

FIG. 2 is a block diagram illustrating a circuit which in an embodiment is a processor controlled to perform steps;

FIG. 3 is a block diagram illustrating a circuit which in an embodiment is a processor controlled to perform steps;

FIG. 4 is a block diagram illustrating a circuit which in an embodiment is a processor controlled to perform steps;

FIG. 5 is a block diagram illustrating a circuit which in an embodiment is a processor controlled to perform steps;

FIG. 6 is a block diagram illustrating a circuit which in an embodiment is a processor controlled to perform steps.

### DETAILED DISCLOSURE OF PREFERRED EMBODIMENTS OF THE INVENTION

In a first embodiment, the method comprises scanning an smtp header for a string which denotes that a message is in the body encoded with an smime certificate. In an embodiment, the string application/x-pkcs7-mime; name=“smime.p7m” is matched in the email header, the email is not transmitted to the recipient, forwarded to a security administrator, or edited, removing content or adding warnings.

In an embodiment, the method comprises scanning an smtp body for a first string and a second string and replacing the text between the strings with a warning. In an embodiment the first string is BEGIN PGP MESSAGE and the second string is END PGP MESSAGE and the warning is NO ENCRYPTED CONTENT ALLOWED.

The present invention further comprises a computer-implemented method comprising controlling a processor to perform the steps of opening an smtp body, scanning for a string comprising - - - BEGIN PGP MESSAGE - - - [0018] scanning for a block of text; scanning far a string comprising - - - END PGP MESSAGE - - - , and replacing the block of text with the string “NO ENCRYPTED CONTENT ALLOWED”.

The present invention further comprises a computer-implemented method comprising controlling a processor to perform the steps of opening an smtp header, scanning for a string comprising application/x-pkcs7-mime; name=“smime.p7m”, and deleting the message. The present invention further comprises a computer-implemented method comprising controlling a processor to perform the steps of [0026] opening a message body, performing a statistical analysis on the number of characters between full stops, performing a statistical analysis on the number of characters between spaces, counting the percentage of words recognized by a dictionary program, and comparing the statistical analysis and percentage of the message body with a statistical analysis and percentage of a natural language. As a well known example typesetters and Samual FB Morse determined the frequency of the letters ETAOINSHRDLU in English. As is known cryptographic methods commonly disguise punctuation and space in ciphertext to a provide few clues to code breakers. A solid block of characters without spaces or punctuation suggests a secret message. So too would constant length strings separated by spaces in constant length lines.

An non-limiting exemplary apparatus for controlling email transmission of encrypted content has an email receiver circuit to receive an electronic mail message an email analysis circuit to determine if an electronic mail message contains unauthorized encrypted content, an email transmitter circuit and an encrypted email block circuit.

An embodiment of an encrypted email block circuit comprises a circuit to forward the email to an administrative or security account. An embodiment of an encrypted email block circuit comprises a circuit to delete the encrypted content and replace it with a warning message. An embodiment of an encrypted email block circuit comprises a circuit to complete the smtp handshake and to store the email. An embodiment of an encrypted email block circuit comprises a circuit to return a smtp reply code in the 400-555 range. Two or more of the above disclosed embodiments may be combined with contradicting the inventive disclosure.

The apparatus can be used in an environment where no or some encrypted email content is tolerated. To support an entity where legitimate use of encrypted email is required for certain authorized uses the email analysis circuit further comprises a policy circuit to determine if an email shall be transferred to the block circuit by applying a policy.

An embodiment of the policy circuit comprises a processor and computer executable instructions encoding a policy wherein a policy defines any encrypted content as unauthorized encrypted content. An embodiment of the policy circuit comprises a processor and computer executable instructions encoding a policy wherein a policy depends on a role of sender within an entity. An embodiment of the policy circuit comprises a processor and computer executable instructions encoding a policy wherein a policy depends on a organizational department of sender. An embodiment of the policy circuit comprises a processor and computer executable instructions encoding a policy wherein a policy depends on a hierarchical level of a sender within an entity. An embodiment of the policy circuit comprises a processor and computer executable instructions encoding a policy wherein a policy depends on time of day and day of week of the electronic mail message or which machine/system is the source. An embodiment of the policy circuit comprises a processor and computer executable instructions encoding a policy wherein a policy depends on a digital signature of the sender or an id attached to the message. An embodiment of the policy circuit comprises a processor and computer executable instructions encoding a policy wherein a policy depends on a public key of the sender or a certificate, or authentication such as a fingerprint.

The present invention further comprises a computer-implemented method comprising controlling a processor to perform the steps of reading a file extension of a file attached to an email, checking enough bytes to confirm the format matches the file extension, and deleting the email if the file extension is an encrypted file extension.

The following is a non-limiting list exemplary file extensions related to encryption:

file extension abiABl-Software Development coder
file extension aclArchiCrypt Live secured data file
file extension aexArmored extracted public encryption key
file extension aexpkArmored extracted public key
file extension afpFileProtector encrypted file
file extension afs3AFS 3 Basic encrypted file
file extension apvpassword file
file extension apwpassword file
file extension attZipLip secure e-mail
file extension binMacbinary II encoded file
file extension bin64Binary encoding method (used by mime complient mail readers)
file extension canCan Encryptor/Decryptor encrypted file
file extension cfeCryptoForge encrypted file
file extension cptCCRYPT encrypted file
file extension cptdBASE encrypted memo file
file extension cxtAdobe Director protected cast file
file extension czipZG encrypted zip archive
file extension dc4ViaThinkSoft (De)Coder file
file extension docenxEgis encrypted Word DOC file
file extension docxenxEgis encrypted Word Open XML DOCX file
file extension dotmenxEgis encrypted DOTM (Word 2007) file
file extension dotxenxEgis encrypted DOTX (Word 2007) file
file extension dpdDekart Private Disk encrypted disk image
file extension dsfPC-TRUST document signer
file extension eccEssential Taceo crypto container
file extension ecrEcrypt encrypted file
file extension eeEncrypt Easy encrypted file
file extension efaEcrypt 2005 encrypted file
file extension eflEncryptafile encrypted file
file extension efrEncryptafile Private Key file
file extension efuEncryptafile Public Key file
file extension egisenxEgis encryped file
file extension encEncoded file—UUENCODEd file (Lotus 1-2-3—uuencode)
file extension encCopySafe PDF encrypted file
file extension encMedia Safe encrypted data
file extension encMy Personal Programmer encrypted distributed project
file extension entEntrust Entelligence secured file
file extension esmEuropay security module
file extension fshCoolfish encrypted file
file extension gifenxEgis encrypted GIF file
file extension grdStrongDisk Encrypted Disk Image
file extension hpgHide Photos encrypted photo container
file extension htmlenxEgis encrypted HTML file
file extension icaIdentity Compass encrypted answers
file extension ifsInfoSlips secure information package
file extension ismSimulationX encrypted model
file extension jpegenxEgis encrypted JPEG file
file extension jpgenxEgis encrypted jPG file
file extension jrltop Secret Crypto Gold top secret journal file
file extension keyAvira AntiVir Personal license key file
file extension keySentry 2020 encryption file
file extension mfsMetFS encrypted FUSE based filesystem file
file extension mhtenxEgis encrypted HTM file
file extension mhtmlenxEgis encrypted MHTML file
file extension mimMulti-Purpose Internet Mail Extensions file
file extension mmeMime encoded
file extension p7Elemica eSignature application
file extension p7bSPC file—cryptographic certificate
file extension p7 mPKCS #7 MIME Message
file extension pc2PrivateChat! file
file extension pdeEncrypted file
file extension pdfenxEgis encrypted PDF file
file extension pemprivacy Enhanced Mail security certificate
file extension pempidgin instant messenger certification file
file extension pfAladdin Systems private file
file extension pfxPersonal Information Exchange
file extension pfxCertificate File
file extension pi2Studio2 high resolution encrypted image
file extension ppkPuTTY Win32 Telnet/SSH client private key
file extension ppsxenxEgis encrypted Powerpoint Open XML PPSX file
file extension pptxenxEgis encrypted Powerpoint Open XML PPTX file
file extension pwlwindows Password file
file extension qzeQZip encrypted file
file extension rarenxEgis encrypted RAR file
file extension rawSentry 2020 encryption file
file extension rifFutuRUG encrypted resident information file
file extension rsaPKCS7 signature file
file extension rzkFile Crypt password file
file extension rzxFile Crypt encrypted file
file extension sefEncryptafile digital signature file
file extension sefsteganos encrypted file
file extension shyShyFile encrypted file
file extension spdSpyProof! encrypted disk data
file extension stm Navy's NOWS secure login file
file extension txtenxEgis encrypted TXT file
file extension uuUuencodeed file archive (ascii)
file extension xiamenxEgis encrypted XLAM (Excel 2007) file
file extension xlsxenxEgis encrypted Excel Open XML XLSX file
file extension zbdZebedee encrypted file
file extension zipenxEgis encrypted ZIP file.

New file formats, file extensions, and methods of determining encrypted content may be provided as upgrades to the policy which is downloaded from a central server. In embodiments, policies can implement rules to allow or exclude certain senders, certain systems, certain messages with ID fields in a database, certain types of encryption,

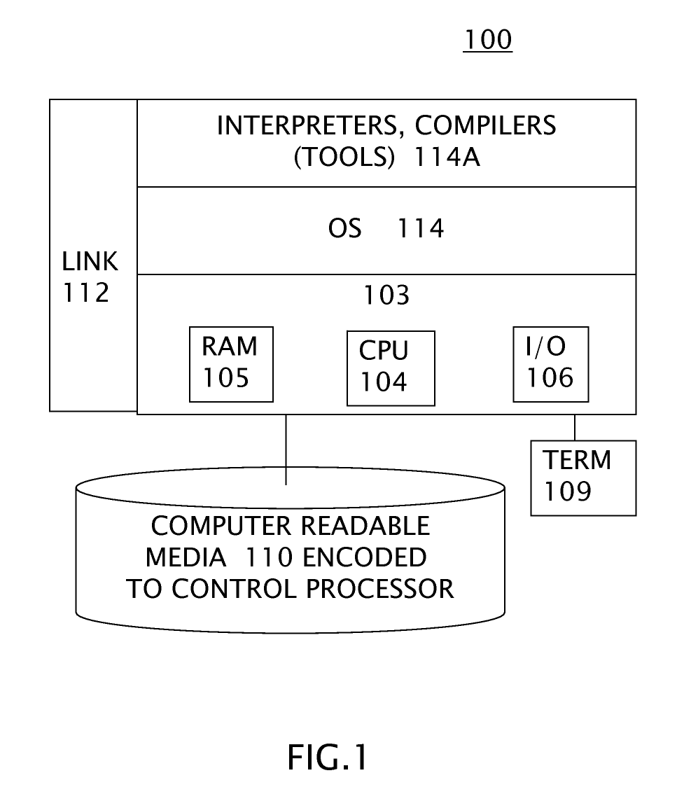

While a policy may simply block all encrypted content sent by any sender, this may prevent email from use in privacy regulated entities. The present invention distinguishes between authorized and unauthorized content by considering the sender and the source machine, attached id's or signatures, or the method of encryption. FIG. 1 shows a block diagram of a typical computing system 100 where the preferred embodiment of this invention can be practiced. The computer system 100 includes a computer platform having a hardware unit 103, that implements the methods disclosed below. The hardware unit 103 typically includes one or more central processing units (CPUs) 104, a memory 105 that may include a random access memory (RAM), and an input/output (I/O) interface 106. Various peripheral components may be connected to the computer platform. Typically provided peripheral components include a terminal 109, an external data storage device (e.g. tape or disk) 110 where the data used by the preferred embodiment is stored. A link 112 may also be included to connect the system 100 to one or more other similar computer systems. The link 112 may also provide access to the global Internet. An operating system (OS) 114 coordinates the operation of the various components of the computer system 100, and is also responsible for managing various objects and files, and for recording certain information regarding same. Lying above the OS 114 is a software tools layer 114A containing, for example, compilers, interpreters and other software tools. The interpreters, compilers and other tools in the layer 114A run above the operating system and enable the execution of programs using the methods known to the art.

One suitable and non-limiting example of computer system 100 is the Barracuda™ Spam Firewall (trademark of Barracuda Networks, Inc.) or a PC running Linux. An example of a suitable CPU is a Pentium™ III processor (trademark of the Intel Corporation); examples of an operating systems is GNU/Linux; examples of an interpreter and a compiler are a Perl interpreter and a C++ compiler. Those skilled in the art will realize that one could substitute other examples of computing systems, processors, operating systems and tools for those mentioned above. As such, the teachings of this invention are not to be construed to be limited in any way to the specific architecture and components shown in FIG. 1.

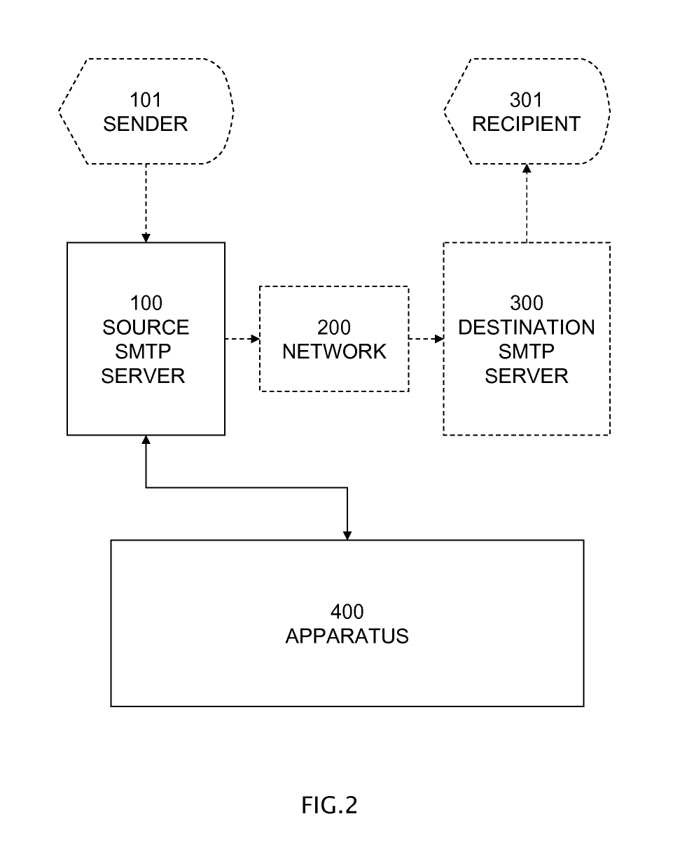

Referring now to FIG. 2 a block diagram shows a non-limiting exemplary system embodiment of the present invention. A sender 101 formulates an email message for a recipient 301 coupled to a destination SMTP server 300, said destination SMTP server is coupled to a public network 200 which in turn couples to a source SMTP server 100. The source SMTP server receives an email from the sender and before forwarding it via the network to the destination SMTP server, extracts certain information as specified in the claims following, for analysis by the apparatus 400 of the present invention. It is know in the art that the inventive apparatus, in an embodiment, comprises a processor controlled by software instructions encoded on computer readable media. It is known that a conventional source SMTP server may embed the inventive apparatus as a software upgrade to its operating system and application program product.

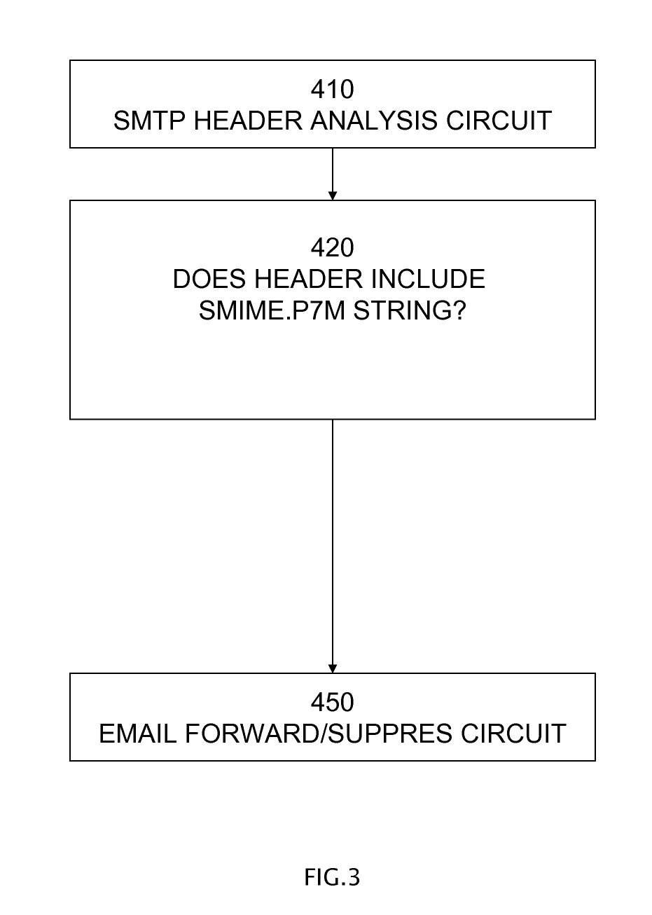

Referring now to FIG. 3, a block diagram illustrates a circuit which in an embodiment may be a processor controlled to perform the following steps: [0146] search header text for a string “SMIME.P7M”, determine to forward or suppress the email.

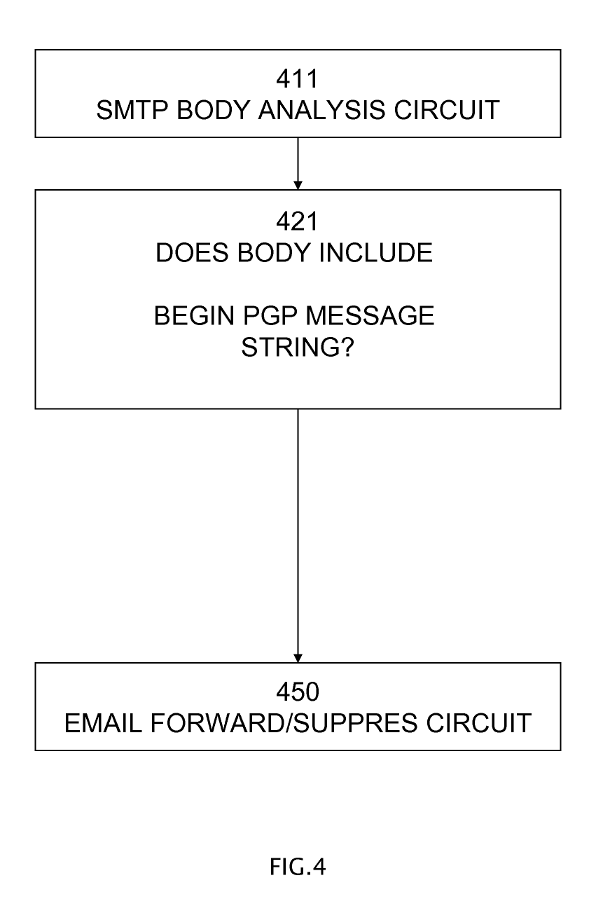

Referring now to FIG. 4, a block diagram illustrates a circuit which in an embodiment may be a processor controlled to perform the following steps: search body text for the strings, “BEGIN PGP MESSAGE” or “END PGP MESSAGE”, determine to forward or suppress the email.

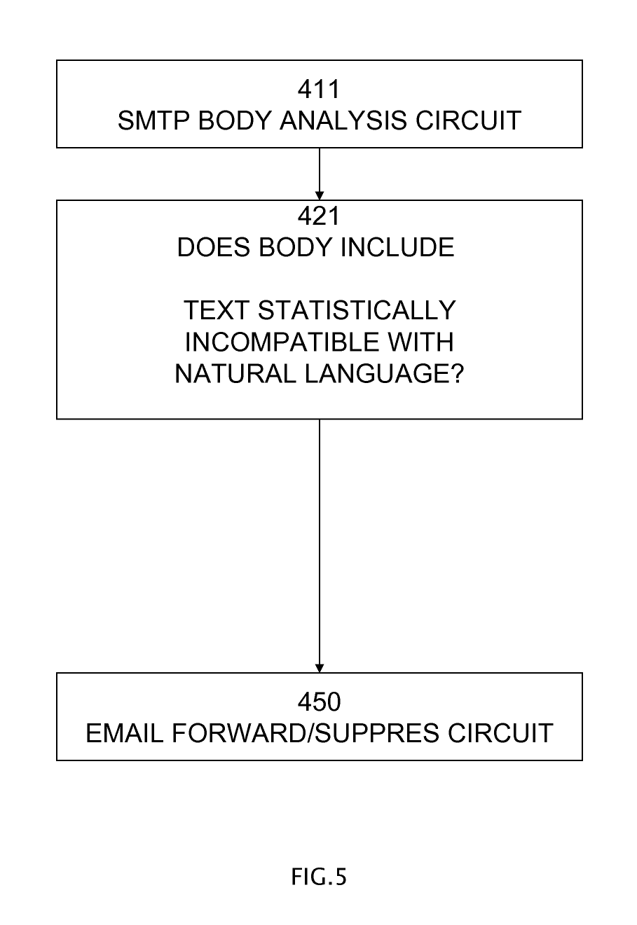

Referring now to FIG. 5, a block diagram illustrates a circuit which in an embodiment may be a processor controlled to perform the following steps: read body of an email; analyze content of body statistically, compare statistics with natural language, determine to forward or suppress the email. It is known that natural language has a characteristic distribution of the frequency of characters, the distribution of word length i.e. the number of characters between spaces, the statistics of the number of characters between punctuation, and the distribution of characters between linefeed/carriage return characters. A dictionary program may score the message body for unknown words and beyond a certain percentage determine that the message is not written in the natural language of the dictionary.

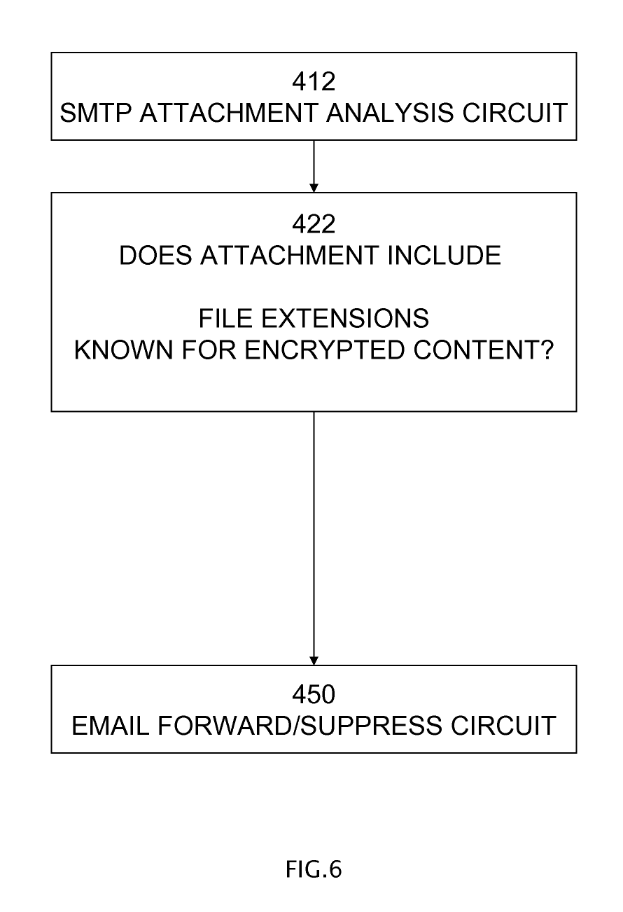

Referring now to FIG. 6, a block diagram illustrates a circuit which in an embodiment may be a processor controlled to perform the following steps: read a file attached to an email; compare email file extension with list of known encryption file extensions; determine to forward or suppress the email.

### CONCLUSION

The present invention is distinguished from conventional email systems which transmit all message body content by the process of controlling transmission of encrypted content according to a policy. In a preferred embodiment, all email which contains encrypted content is blocked except for email that can be determined to originate from certain senders, such as characterized by a digital signature, or a public key, or a certificate.

Significantly, this invention can be embodied in other specific forms without departing from the spirit or essential attributes thereof, and accordingly, reference should be had to the following claims, rather than to the foregoing specification, as indicating the scope of the invention. Within the present application, an embodiment of a circuit comprises a processor controlled by software instructions encoded on computer-readable media, coupled to the processor.

I claim:

1. An apparatus for controlling email transmission of encrypted content comprising an email receiver circuit to receive an electronic mail message an email analysis circuit to determine if an electronic mail message contains unauthorized encrypted content, an email transmitter circuit and an encrypted email block circuit.

2. The apparatus of claim 1 wherein a block circuit comprises a circuit to forward the email to an administrative or security account.

3. The apparatus of claim 1 wherein a block circuit comprises a circuit to delete the encrypted content and replace it with a warning message.

4. The apparatus of claim 1 wherein a block circuit comprises a circuit to complete the smtp handshake and to store the email.

5. The apparatus of claim 1 wherein a block circuit comprises a circuit to return a smtp reply code in the 400-555 range.

6. The apparatus of claim 1 wherein the email analysis circuit further comprises a policy circuit to determine if an email shall be transferred to the block circuit by applying a policy and wherein any circuit of claim 1 comprises a processor controlled by software instructions.

7. The apparatus of claim 6 wherein a policy defines any encrypted content as unauthorized encrypted content.

8. The apparatus of claim 6 wherein a policy depends on a role of sender within an entity.

9. The apparatus of claim 6 wherein a policy depends on a organizational department of sender.

10. The apparatus of claim 6 wherein a policy depends on a hierarchical level of a sender within an entity.

11. The apparatus of claim 6 wherein a policy depends on time of day and day of week of the electronic mail message.

12. The apparatus of claim 6 wherein a policy depends on a digital signature of the sender.

13. The apparatus of claim 6 wherein a policy depends on a public key of the sender.
